(19) United States
(12) Patent Application Publication
(10) Pub. No.: US 2026/0091642 A1
(43) Pub. Date: Apr. 2, 2026

(54) REGISTER ASSEMBLY FOR A VEHICLE

(71) Applicant: Ford Global Technologies, LLC, Dearborn, MI (US)

(72) Inventors: Luis Flores Alonso, Mexico City (MX); Thomas Junior Luckett, Saline, MI (US); Benjamin John Keur, Northville, MI (US); Alfonso Rojas Galván, Mexico City (MX); Alba Elena Vázquez Hernández, Chimalhuacan (MX); Ricardo Galicia Lopez, Mexico City (MX); Hedy Humberto Morales Bolaños, Mexico City (MX); Ruben Gallardo Sanchez, Mexico City (MX)

(73) Assignee: Ford Global Technologies, LLC, Dearborn, MI (US)

(21) Appl. No.: 18/901,871

(22) Filed: Sep. 30, 2024

(51) Int. Cl. B60H 1/00; B60H 1/34

(52) U.S. Cl. CPC B60H 1/0055; B60H 1/3421

(57) ABSTRACT

A vehicle dashboard assembly including a substrate secured to a vehicle body structure. A topper panel is operably coupled to the substrate. A register assembly is engaged with the topper panel. The register assembly is positioned on a top surface of the topper panel such that the register assembly is elevated relative to the topper panel. The register assembly includes a register carrier operably coupled to the substrate, wherein the register carrier defines an open area. A top cover is operably coupled to the register carrier, wherein top cover encloses the open area. A cap extends from the top cover to abut the topper panel, wherein the cap creates an interface with the topper panel to form a slope. The slope is configured to position the register assembly on top of the surface of the topper panel.

### FIELD OF THE DISCLOSURE

The present disclosure generally relates to a vehicle instrument panel, and more particularly, to a register assembly for a vehicle.

### BACKGROUND OF THE DISCLOSURE

Vehicle instrument panels generally include register assemblies configured to support the airflow within a vehicle. Known vehicles may include air registers, screens, and other similar systems mounted on an instrument panel positioned in various locations.

### SUMMARY OF THE DISCLOSURE

According to a first aspect of the present disclosure, a dashboard assembly for a vehicle includes a substrate configured to be secured to a vehicle body structure, a topper panel secured to the substrate, and a register assembly engaged with the topper panel having a forward end and a rearward end. The rearward end of the register assembly defines a slope that vertically displaces the register assembly relative to the topper panel. The register assembly includes a first carrier and a second carrier coupled to the substrate. A first top cover is operably coupled to the first carrier and a second top cover is operably coupled to the second carrier. Each of the first top cover and the second top cover includes a front edge and a rear edge. A first cap extends from the rear edge of the first top cover and a second cap extends from the rear edge of the second top cover. The first cap and the second cap abut the topper panel, and a speaker housing operably couples the first top cover and the second top cover.

Embodiments of the first aspect of the present disclosure can include any one or a combination of the following features:
each of the first carrier and the second carrier define an open area;
at least one air register is disposed in the open area of each of the first carrier and the second carrier;
the first carrier and the second carrier include an internal surface having a plurality of tabs extending therefrom, wherein the plurality of tabs are configured to couple the at least one air register to the respective carrier;
the first carrier and the second carrier include a plurality of screw tabs configured to align with apertures defined by the substrate to secure the first carrier and the second carrier to the substrate via a fastener;
each of the first carrier and the second carrier include a first end and a second end, the second end of each of the first carrier and second carrier defining an aperture, and wherein the apertures of the second ends align to receive a fastener to couple the first carrier and the second carrier;
the speaker housing includes an interior from which a projection extends, and wherein the projection is configured to engage with the first carrier and the second carrier;
the slope defined by the register assembly positions the register assembly on top of the topper panel;
the first carrier and the second carrier define airflow openings, and wherein the position of the register assembly on top of the topper panel is configured to redirect air current from the airflow openings to reduce drafts;
a lip portion coupled to the substrate and engaged with the first carrier and the second carrier; and
the forward end of the register assembly is vertically displaced relative to the topper panel and the rearward end of the register assembly is vertically displaced relative to the lip portion of the instrument panel, wherein the vertical displacement of the forward end and the rearward end of the register assembly is configured to form an elevated configuration of an entirety of the register assembly.

According to a second aspect of the present disclosure, a vehicle dashboard assembly includes a substrate configured to be secured to a vehicle body structure. A topper panel is operably coupled to the substrate. A register assembly is engaged with the topper panel, wherein the register assembly is positioned on a top surface of the topper panel such that the register assembly is elevated relative to the topper panel. The register assembly includes a register carrier operably coupled to the substrate, wherein the register carrier defines an open area. A top cover is operably coupled to the register carrier, wherein the top cover encloses the open area. A cap extends from the top cover to abut the topper panel, wherein the cap creates an interface with the topper panel to form a slope, and wherein the slope is configured to position the register assembly on top of the surface of the topper panel.

Embodiments of the second aspect of the present disclosure can include any one or a combination of the following features:
an air register disposed in the register carrier, wherein the register carrier defines an air flow opening proximate the air registers, and a lip portion coupled to the substrate and engaged with the register carrier, wherein the lip portion is positioned proximate the airflow opening of the register carrier such that air released by the air register contacts the lip portion;
a speaker housing including a grille portion, wherein the speaker housing is positioned in a central location along the top cover; and
the register assembly includes a speaker disposed in the open area of the register carrier proximate the speaker housing.

According to a third aspect of the present disclosure, a vehicle dashboard assembly includes a topper panel secured to a vehicle body, and a register assembly engaged with the topper panel. The register assembly is vertically displaced from the topper panel such that the register assembly is disposed on the topper panel. The register assembly includes a register carrier coupled to the vehicle body, wherein the register carrier defines an open area. A top cover is operably coupled to the register carrier and is configured to cover the open area, wherein the top cover includes a front edge and a rear edge.
a cap extending from the rear edge of the top cover to abut the topper panel, wherein the cap creates an interface with the topper panel to form a slope such that the register assembly is elevated relative to the topper panel;
the top cover includes a flange defining a slot and the cap includes a clip, and wherein the slot of the top cover is configured to receive the clip of the cap;
the slope defines a height measuring between 10 mm and 30 mm; and
a speaker housing operably coupled to the top cover, wherein the speaker housing includes a grille portion, and a speaker cover configured to engage with the speaker, wherein the speaker cover and the speaker housing are positioned in a central location relative to the top cover.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a dashboard assembly within an interior compartment of a vehicle;

FIG. 2 is an exploded view of a dashboard assembly for a vehicle including a cover cap, speaker housing, top cover, air registers, and register carriers;

FIG. 3A is a front elevational view of a first register carrier and a second register carrier of a dashboard assembly for a vehicle;

FIG. 3B is a side perspective view of an interior of a first register carrier and a second register carrier of a dashboard assembly for a vehicle;

FIG. 4 is a partial side perspective view of a register carrier defining an open area with a pair of air registers disposed in the open area;

FIG. 5 is an exploded view of a dashboard assembly including a lip portion of a vehicle instrument panel;

FIG. 6 is a first register carrier and a second register carrier coupled to each other via end pieces, where the first and second register carriers define an intermediate open space with a speaker housing disposed therein;

FIG. 7 is a cross-sectional view of a dashboard assembly including a projection proximate a register carrier;

FIG. 8 is a side perspective view of a top cover including screw flanges proximate slot flanges;

FIG. 9 is a partial side perspective view of a slot flange defining a slot extending from a top cover with a clip received by the slot; and

FIG. 10 is a cross-sectional view of a dashboard assembly including a slope defined by a cover cap extending from a rear edge of a top cover.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

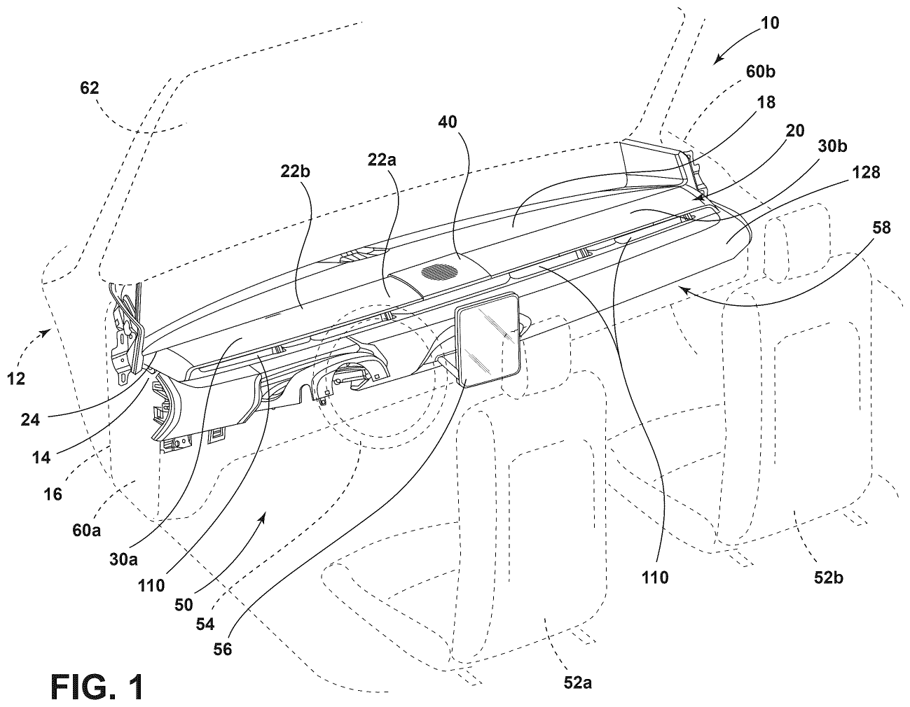

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a dashboard assembly having a register assembly for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

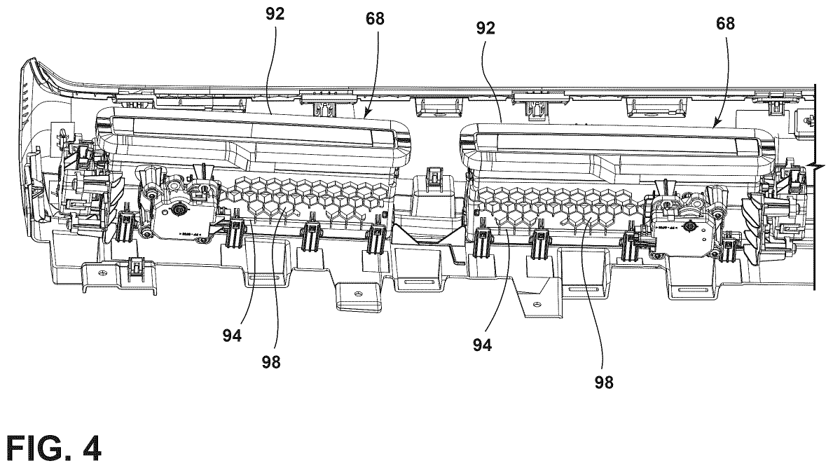

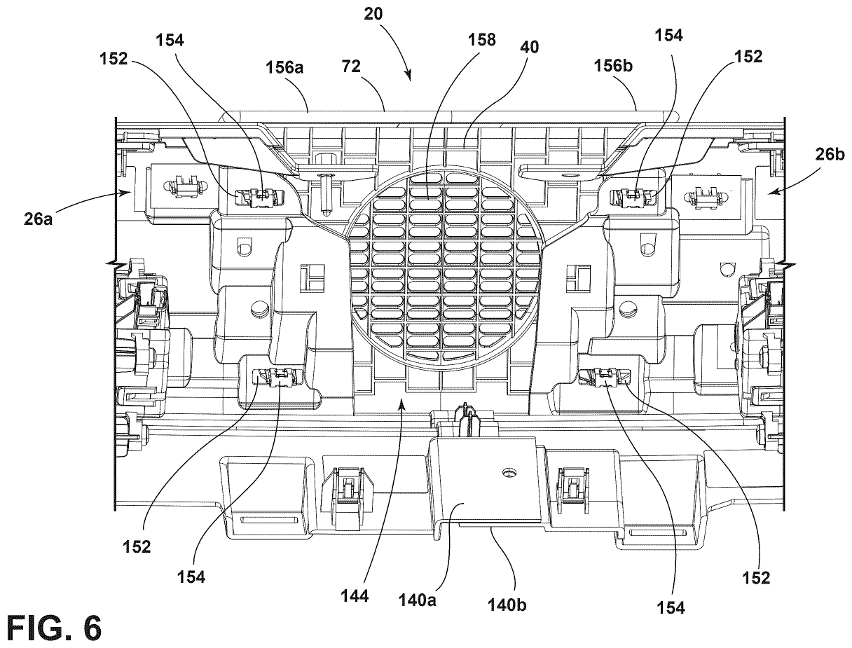

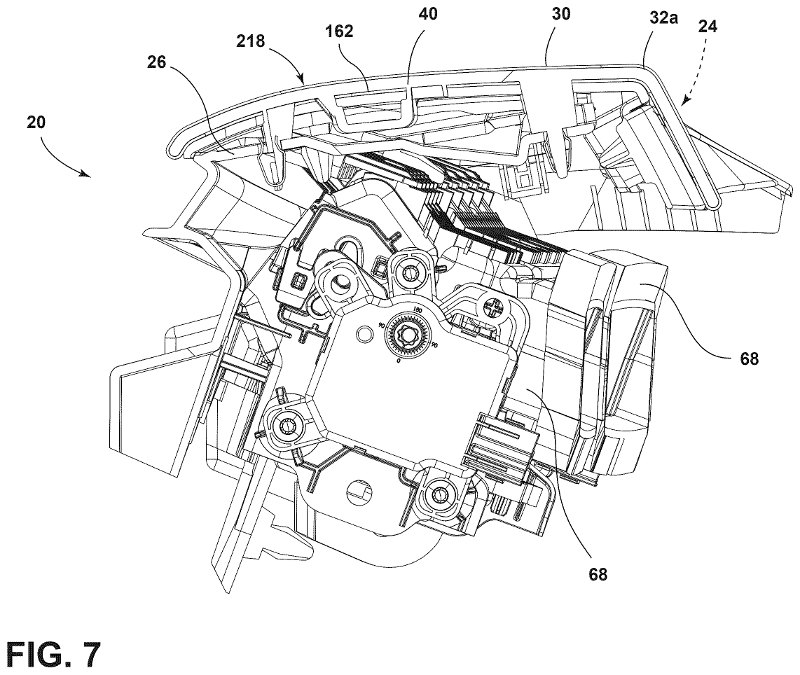

Referring to FIGS. 1-10, reference numeral 10 generally designates a dashboard assembly for a vehicle 12. A substrate 14 may be configured to be secured to a vehicle body 16 structure. A topper panel 18 is secured to the substrate 14. A register assembly 20 is engaged with the topper panel 18 and includes a forward end 22a and a rearward end 22b. The rearward end 22b of the register assembly 20 defines a slope 24 that vertically displaces the register assembly 20 relative to the topper panel 18. The register assembly 20 includes a first register carrier 26a, also referred to as a driver register carrier 26a, and a second register carrier 26b, also referred to as a passenger register carrier 26b, which may be collectively referred to herein as the register carriers 26. The register carriers 26 may be coupled to the substrate 14. The register assembly 20 may also include a first top cover 30a and a second top cover 30b, which may be collectively referred to herein as the top covers 30. The first top cover 30a is operably coupled to the first register carrier 26a and the second top cover 30b is operably coupled to the second register carrier 26b. Each of the top covers 30 include a front edge 32a and a rear edge 32b. The register assembly 20 includes a first cover cap 36a and a second cover cap 36b, which may be collectively referred to herein as the cover caps 36. The first cover cap 36a extends from the rear edge 32b of the first top cover 30a and the second cover cap 36b extends from the rear edge 32b of the second top cover 30b. The cover caps 36 abut the topper panel 18. A speaker housing 40 operably couples the first top cover 30a and the second top cover 30b.

Referring to FIG. 1, the vehicle 12 is generally illustrated as having the vehicle body 16 defining an interior compartment 50, which includes seating assemblies 52 for supporting passengers thereon, such as a driver seating assembly 52a and a passenger seating assembly 52b. The interior compartment 50 generally includes a front row of seating assemblies 52 including a driver seat and a passenger seat. Located forward of the driver seat is a steering wheel 54 and a center display 56. A trim panel in the form of a dashboard or an instrument panel 58 extends forward of the first row of seating and forward of the steering wheel 54 in a cross-car direction between lateral sides 60a,60b of the vehicle body 16 proximate the seating assemblies 52. Additionally, the vehicle body 16 includes a windshield 62 generally extending across the front end of the interior compartment 50.

The vehicle 12 may be a sedan, a sport utility vehicle, a van, a truck, a crossover, other styles of wheeled motor vehicles, or other styles of vehicles. The vehicle 12 may be a manually operated vehicle (e.g., operated with a human driver), a fully autonomous vehicle (e.g., operated without a human driver), or a partially autonomous vehicle (e.g., operated with or without a human driver). Additionally, the vehicle 12 may be utilized for personal and/or commercial purposes, such as for ride-providing services (e.g., chauffeuring), transporting, and/or ride-sharing services.

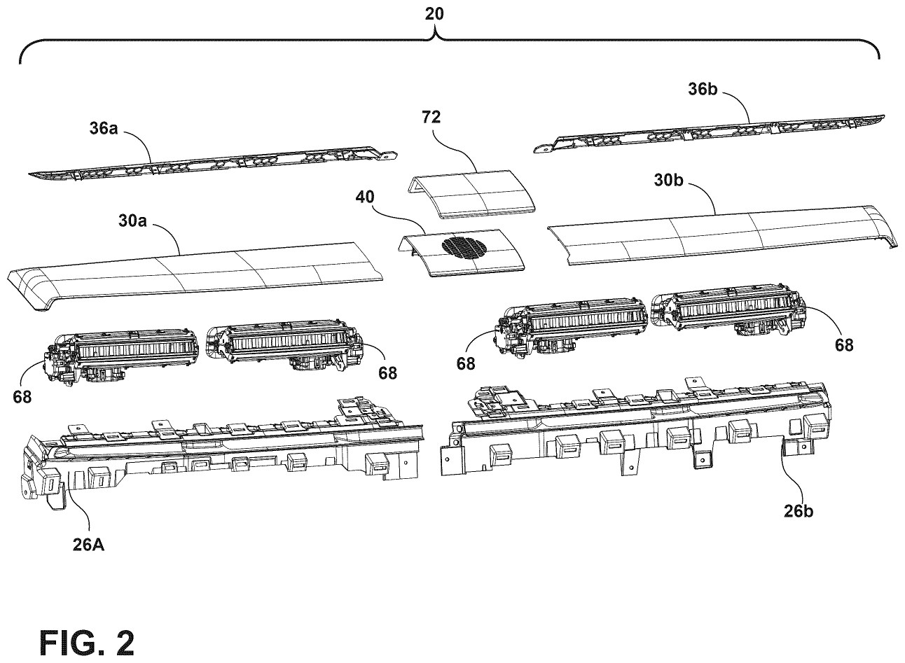

Referring still to FIG. 1, as well as FIG. 2, the register assembly 20 includes the first register carrier 26a, which is generally a left-side register carrier 26a when a driver is seated in the vehicle 12. Additionally, the register assembly 20 includes the second register carrier 26b, which is generally a right-side register carrier 26b when a passenger is seated in the vehicle 12. Each of the first and second register carriers 26a, 26b define an open area 66. Disposed within the open area 66 of the first register carrier 26a is a first air register assembly consisting of a pair of air registers 68. Disposed within the second register carrier 26b is a second air register assembly consisting of another pair of air registers 68. As such, the first register carrier 26a and the second register carrier 26b may generally mirror each other. It is contemplated that each of the first and second register carriers 26a, 26b may include more or fewer than the pair of air registers 68 described herein.

The register assembly 20 further includes the first top cover 30a and the second top cover 30b. The top covers 30 are configured to engage the first and second register carriers 26a, 26b, respectively, to assist in coupling the register carriers 26 to one another and to provide structural support to the first and second register carriers 26a, 26b, respectively. The top covers 30 may cover a portion of the open area 66 of the register carriers 26 to conceal internal components, such as the air registers 68, and may contribute to a more refined appearance of the register assembly 20. Additionally, the speaker housing 40 is positioned between each of the top covers 30 and is operably coupled to the top covers 30, as is further described herein. The speaker housing 40 may include a cover 72 that may assist in coupling the speaker housing 40 to the top covers 30 creating a uniform cover over the register assembly 20.

The register assembly 20 may include the first cover cap 36a and the second cover cap 36b. The cover caps 36 may be operably coupled to a rear portion of the top covers 30. For example, the cap covers 36 may extend from the rear edge 32b of the top covers 30 proximate the rearward end 22b of the register assembly 20. The cover caps 36 may be narrower than the top covers 30 and may cover the remaining portions of the open area 66 defined by the register carriers 26. Accordingly, the first cover cap 36a may be used to cover the remaining portions of the open area 66 defined by the first register carrier 26a and the second cover cap 36b may be used to cover the remaining portions of the open area 66 defined by the second register carrier 26b.

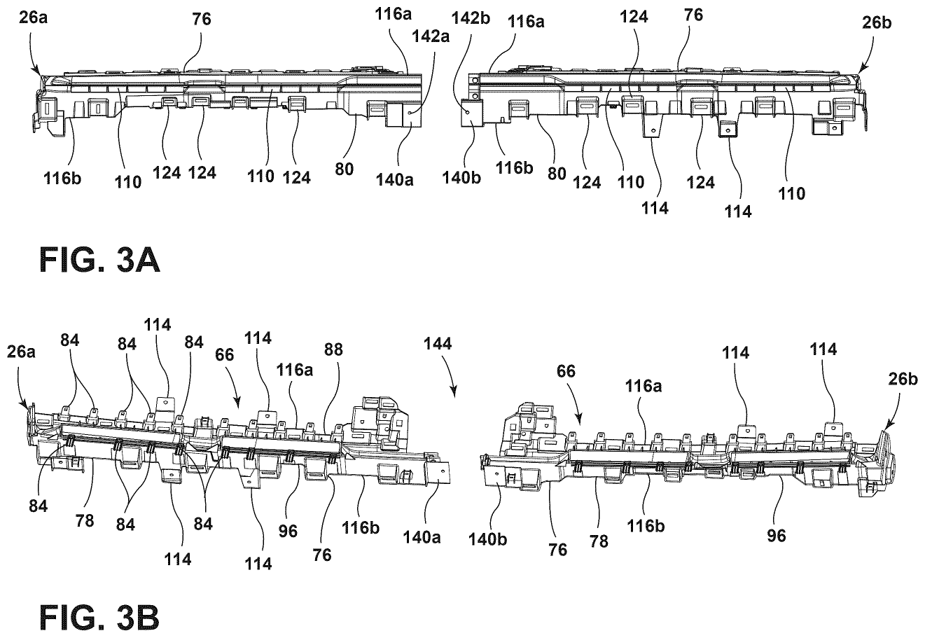

Referring now to FIGS. 3-5, each of the register carriers 26 include an elongate body 76 extending between the lateral sides 60a, 60b of the vehicle body 16 and a portion of the instrument panel 58. For example, the first register carrier 26a may extend between the lateral side 60a proximate the driver seating assembly 52a and a generally central location along the instrument panel 58. Accordingly, the second register carrier 26b may extend from the opposing lateral side 60b of the vehicle body 16 proximate the passenger seating assembly 52b and the generally central location along the instrument panel 58 proximate the first register carrier 26a. The register carriers 26 may align with one another at the generally central location along the instrument panel 58 to couple the register carriers 26 to each other, as is further described herein. Additionally, the elongate body 76 of the register carriers 26 include an internal surface 78 proximate the open area 66 and an external surface 80 proximate the seating assemblies 52. Each of the internal surface 78 and the external surface 80 include components that assist in coupling the register carriers 26 to one another and the instrument panel 58.

The register carriers 26 include a multitude of connection points to operably couple the register carriers 26, and consequently the register assembly 20, to the instrument panel 58. For example, the internal surface 78 of the elongate body 76 may include a number of tabs 84 extending from the elongate body 76 of the register carriers 26 that are configured to couple the air registers 68 to the register carriers 26. Each of the tabs 84 may define an aperture to assist in coupling the air registers 68 to the register carriers 26. For example, five tabs 84 may extend from an upper portion 88 of the internal surface 78 of the elongate body 76 of the register carriers 26. The apertures of the five tabs 84 may receive nodules positioned along a top wall 92 of a housing 94 of the air registers 68. Additionally, four tabs 84 may extend from a lower portion 96 of the internal surface 78 of the elongate body 76 of the register carriers 26. The apertures of the four tabs 84 may receive nodules positioned along a bottom wall 98 of the housing 94 of the air registers 68. Accordingly, the tabs 84 assist in aligning the air registers 68 with an airflow opening 110 defined by the register carriers 26, and consequently, securing the air registers 68 to the respective register carriers 26. It is contemplated, however, that additional tabs 84 may engage with the housing 94 of the air registers 68 or less than the described tabs 84 may engage with the housing 94 of the air registers 68 to secure the air registers 68 to the register carriers 26.

The register carriers 26 may further include screw tabs 114 disposed along a top edge 116a and a bottom edge 116b of the elongate body 76 of the register carriers 26. For example, the top edge 116a of the elongate body 76 of the register carriers 26 may include a pair of screw tabs 114 configured to align with apertures defined by the substrate 14. The bottom edge 116b of the elongate body 76 of the register carriers 26 may include three screw tabs 114 configured to align with additional apertures defined by the substrate 14 of the instrument panel 58. Each of the pair of screw tabs 114 on the top edge 116a of the register carriers 26 and the three screw tabs 114 on the bottom edge 116b of the register carriers 26 may be configured to receive fasteners to couple the register carriers 26 to the substrate 14. However, it is contemplated that the register carriers 26 may include more or fewer screw tabs 114 and may be disposed on the register carriers 26 in various configurations without departing from the teachings described herein.

Referring still to FIGS. 3-5, the register carriers 26 include additional connection points to further assist in securing the register carriers 26 to the instrument panel 58. For example, the register carriers 26 may include slots 124 that extend from the external surface 80 to internal surface 78 of the register carriers 26 along the top edge 116a and the bottom edge 116b. The slots 124 are configured to receive clips disposed along a lip portion 128 or lip feature of the instrument panel 58. For example, the lip portion 128 of the instrument panel 58 is positioned proximate to the airflow openings 110 of the register carriers 26 such that air released by the air registers 68 may come in contact with the lip portion 128 of the instrument panel 58. Accordingly, the lip portion 128 extends from the substrate 14 towards the center display 56. When the clips of the lip portion 128 are received by the slots 124 of the register carriers 26, the lip portion 128 may be secured to the register carriers 26, and consequently, the register assembly 20. Additionally, in various examples, the register carriers 26 may include slots 124 that extend between the external surface 80 and the internal surface 78 of the register carriers 26 along the top edge 116a. The slots 124 are configured to receive clips disposed along an interior of the top covers 30, respectively, to secure the top covers 30 to the register carriers 26.

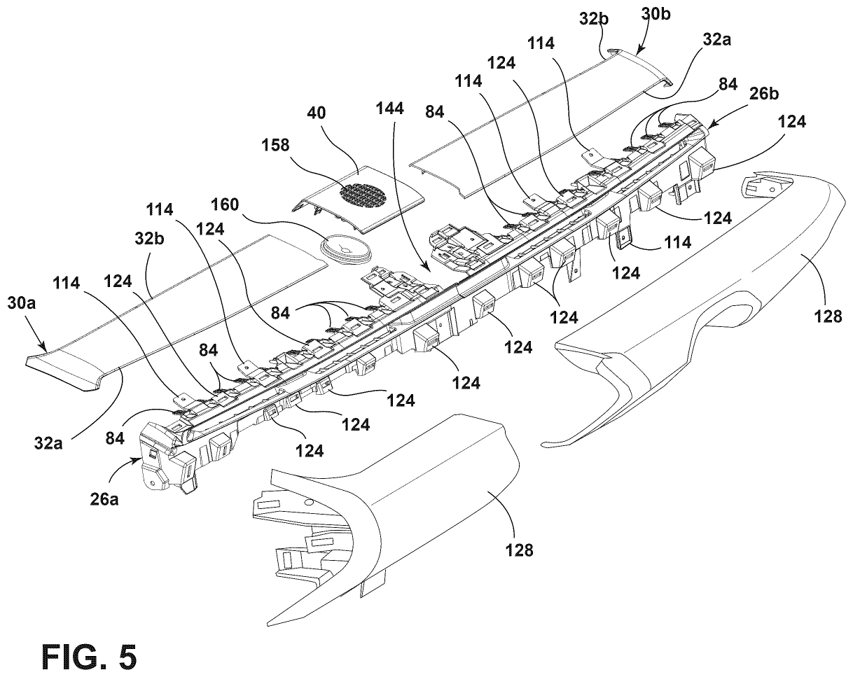

Referring now to FIGS. 5-7, the bottom edge 116b of each of the register carriers 26 includes an end piece 140a, 140b, respectively, that is generally square in shape, however, other shapes may be contemplated. In various examples, the end piece 140a of the first register carrier 26a defines an aperture 142a and aligns with the end piece 140b of the second register carrier 26b defining a corresponding aperture 142b. When the apertures 142a, 142b of each of the respective end pieces 140a, 140b of the register carriers 26 align, a fastener may be received to couple the register carriers 26 to each other, as well as to the substrate 14. As such, the register carriers 26 may be secured to one another at the bottom edge 116b and coupled to the instrument panel 58. Accordingly, the engagement point of the register carriers 26 at the bottom edge 116b of the elongate body 76 at least partially define an intermediate open space 144. The intermediate open space 144 is configured to receive the speaker housing 40, as is further described herein.

Referring still to FIGS. 5-7, the register carriers 26 include a pair of housing slots 152 proximate the end pieces 140a, 140b. The housing slots 152 may be configured to receive clips 154 disposed on opposing sides 156a, 156b of the speaker housing 40. When the clips 154 of the speaker housing 40 are received by the housing slots 152 of the register carriers 26, the speaker housing 40 may generally cover the intermediate open space 144. Accordingly, the speaker housing 40 may be generally positioned at a central location relative to the register assembly 20 and may include a grille portion 158. The grille portion 158 may include a mesh lining positioned in a central location on the speaker housing 40. The grille portion 158 may assist in transferring sound waves from a speaker 160 disposed directly below the speaker housing 40 to the interior compartment 50 of the vehicle 12.

The speaker 160 may be disposed on the instrument panel 58 positioned proximate the speaker housing 40, for example, directly beneath the speaker housing 40. The speaker housing 40 assists in protecting the speaker 160 from environmental factors while optimizing sound quality. For example, the grille portion 158 of the speaker housing 40 may include acoustic dampening materials to reduce vibrations and resonances. In various examples, the grille portion 158 may be removable for ease of access to the speaker 160 for maintenance or replacement purposes. The grille portion 158 may also incorporate design elements that complement the overall aesthetic of the instrument panel 58. Additionally, opposing sides 156a, 156b of the speaker housing 40 may include a projection 162 that extends from an interior of the speaker housing 40. The projection 162 may be a generally 3-tiered projection 162 forming a jagged-edge conical shape with a flat-tipped edge. The projection 162 may engage with the top edge 116a of the register carriers 26 to increase retention of the speaker housing 40 to the register carriers 26 further securing the speaker housing 40 thereto. During assembly, the cover 72 may be engaged with the speaker housing 40 and the top covers 30 to further protect the speaker 160 from environmental factors and to create a uniform design for the register assembly 20 when positioned on the instrument panel 58.

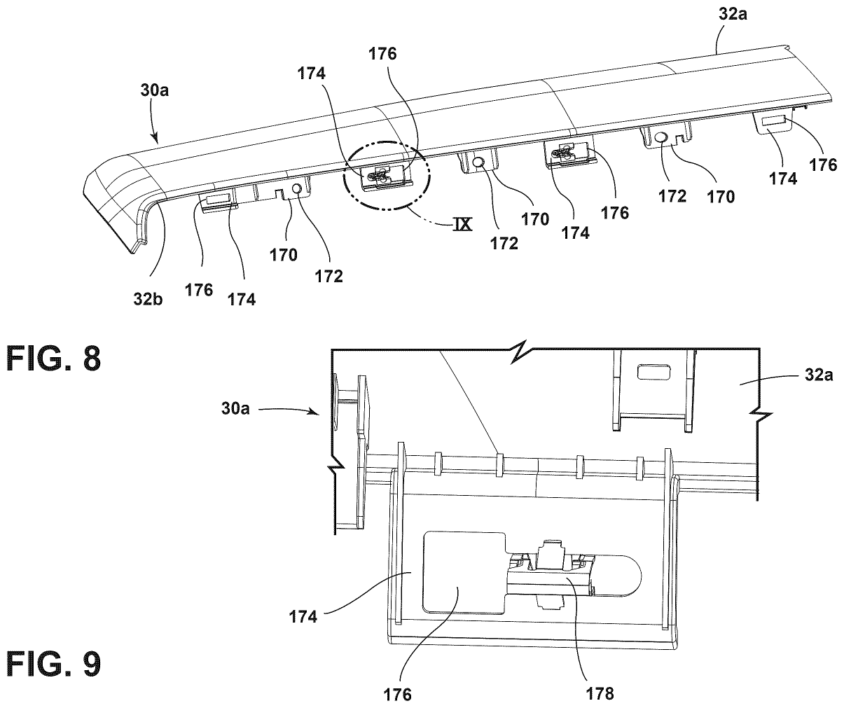

Referring now to FIGS. 8 and 9, as noted herein, the top covers 30 engage with each of the respective register carriers 26 to cover the open area 66 defined therein. Each of the top covers 30 include a multitude of flanges extending from the rear edge 32b configured to couple the top covers 30 to the instrument panel 58 and the register carriers 26. For example, each of the first top cover 30a and the second top cover 30b may include screw flanges 170, such as three screw flanges 170, extending from the rear edge 32 with each screw flange 170 defining an aperture 172 configured to receive a fastener to secure each of the top covers 30 to the instrument panel 58 or the topper panel 18. Additionally, or alternatively, each of the top covers 30 may include four slot flanges 174 defining a slot 176 extending from the rear edge 32b proximate the screw flanges 170. The slot flanges 174 are configured to receive clips 178 disposed along an interior of the cover caps 36. The clips 178 of each of the cover caps 36 extend through the slots 176 of the slot flanges 174 to assist in securing each of the cover caps 36 to the respective top covers 30, as well as to reduce detachment of the cover caps 36 or the top covers 30 during rigorous vehicular movement.

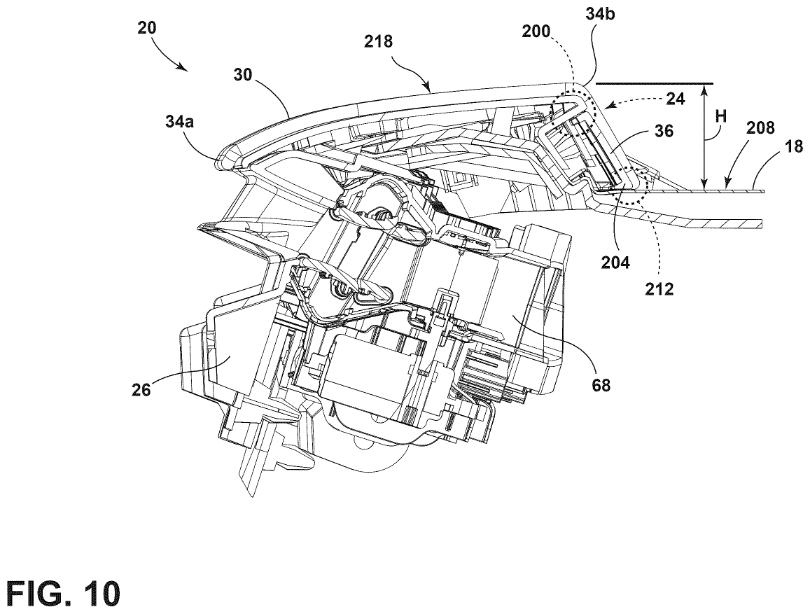

Referring now to FIG. 10, during assembly, various interfaces between components of the register assembly 20 and the instrument panel 58 may be created. For example, when the cover caps 36 are operably coupled to the top covers 30 a top edge of the cover caps 36 abuts the rear edge 32b of the top cover 30 to create a top cover-cover cap interface 200. In another example, when the register assembly 20 is fully assembled and disposed atop the instrument panel 58, such as the topper panel 18, a bottom edge 204 of the cover caps 36 abuts a surface 208 of the topper panel 18 to create a cover cap-topper panel interface 212. Additionally, when the register assembly 20 is fully assembled, the forward end 22a of the register assembly 20 including a portion of the top covers 30 and the cover caps 36 are configured to engage with and/or be disposed on the lip portion 128 of the instrument panel 58. The rearward end 22b of the register assembly 20 including a portion of the register carriers 26 and the top covers 30 are configured to engage with and/or be disposed on the topper panel 18. Accordingly, the rearward end 22b is positioned proximate the windshield 62 and the forward end 22a is positioned proximate the center display 56.

Referring still to FIG. 10, the top covers 30 of the register assembly 20 define a curvature 218 extending from the front edge 32a to the rear edge 32b. As described herein, the cover caps 36 extend from the rear edge 32b of the top covers 30 to abut the topper panel 18. Accordingly, the cover cap-topper panel interface 212 forms the slope 24 defining a height H. The height H of the slope 24 may measure between approximately 10 mm to approximately 30 mm. The creation of the slope 24 allows for the register assembly 20 to be positioned atop the topper panel 18 such that the register assembly 20 is vertically displaced from the instrument panel 58. In conventional register assembly configurations, the register assembly 20 may be flush with the instrument panel 58 or may be embedded within the lip portion 128 of the register assembly 20. However, in the configuration depicted in FIGS. 1 and 10, the register assembly 20 is vertically displaced from, or elevated, such that it is positioned above the topper panel 18, and consequently, the instrument panel 58.

Accordingly, the elevation of the register assembly 20 relative to the topper panel 18 via the slope 24, creates a distinct visual appearance and may assist in increasing aerodynamic functionality. For example, the elevation of the register assembly 20 formed by the slope 24 may assist in managing airflow within the interior compartment 50 of the vehicle 12. The elevation may redirect air current provided by the air registers 68 to reduce drafts and improve overall climate control efficiency within the vehicle 12. The slope 24 may further contribute to a reduction in fogging of the windshield 62 by maintaining uniform air circulating patterns near the windshield 62 surface. Additionally, in various examples, the slope 24 may incorporate additional functional elements, such as proximity sensors for gesture control of an infotainment system or discrete openings for interior microphones, speakers, and other similar systems.

Use of the present device and system may provide for a variety of advantages. For example, the elevated design of the register assembly 20 offers both functional and aesthetic benefits. The elevated position of the register assembly 20 improves airflow management within the interior compartment 50 to assist in managing climate control efficiency and reduction of windshield 62 fogging. The slope 24 or step formed by the register assembly 20 creates a visually distinctive element in the instrument panel 58, contributing to a more premium appearance of the instrument panel 58 of the vehicle 12. The integrated design of the register carriers 26, top covers 30, and speaker housing 40 allow for efficient use of space while providing a cohesive, uniform appearance to the dashboard or instrument panel 58. The multitude of connection points and secure attachment methods ensure stability and durability of the assembly, in particular, during rigorous vehicular movement. Additionally, the modular nature of the components, such as the removable grille portion 158 and cover caps 36, facilitates ease of maintenance and customization. The design of the register assembly 20 allows for a more compact appearance to the assembly to create a condensed unit while allowing proper fitment and functionality of the air registers 68 disposed within the register assembly 20.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A dashboard assembly for a vehicle, comprising:
a substrate configured to be secured to a vehicle body structure;
a topper panel secured to the substrate; and
a register assembly engaged with the topper panel having a forward end and a rearward end, wherein the rearward end of the register assembly defines a slope that vertically displaces the register assembly relative to the topper panel, the register assembly including:
a first carrier and a second carrier coupled to the substrate;
a first top cover operably coupled to the first carrier and a second top cover operably coupled to the second carrier, wherein each of the first top cover and the second top cover include a front edge and a rear edge;
a first cap extending from the rear edge of the first top cover and a second cap extending from the rear edge of the second top cover, wherein the first cap and the second cap couple the topper panel; and
a speaker housing coupling the first top cover and the second top cover.

2. The dashboard assembly of claim 1, wherein each of the first carrier and the second carrier define an open area.

3. The dashboard assembly of claim 2, wherein at least one air register is disposed in the open area of each of the first carrier and the second carrier.

4. The dashboard assembly of claim 3, wherein the first carrier and the second carrier include an internal surface having a plurality of tabs extending therefrom, and wherein the plurality of tabs are configured to couple the at least one air register to the respective carrier.

5. The dashboard assembly of claim 1, wherein the first carrier and the second carrier include a plurality of screw tabs configured to align with apertures defined by the substrate to secure the first carrier and the second carrier to the substrate via a fastener.

6. The dashboard assembly of claim 1, wherein each of the first carrier and the second carrier include a first end and a second end, the second end of each of the first carrier and second carrier defining an aperture, and wherein the apertures of the second ends align to receive a fastener to couple the first carrier and the second carrier.

7. The dashboard assembly of claim 1, wherein the speaker housing includes an interior from which a projection extends, and wherein the projection is configured to engage with the first carrier and the second carrier.

8. The dashboard assembly of claim 1, wherein the slope defined by the register assembly positions the register assembly on top of the topper panel.

9. The dashboard assembly of claim 1, wherein the first carrier and the second carrier define airflow openings, and wherein the position of the register assembly on top of the topper panel is configured to redirect air current from the airflow openings to reduce drafts.

10. The dashboard assembly of claim 1, further comprising:
a lip portion coupled to the substrate and engaged with the first carrier and the second carrier.

11. The dashboard assembly of claim 10, wherein the forward end of the register assembly is vertically displaced relative to the topper panel and the rearward end of the register assembly is vertically displaced relative to the lip portion of the instrument panel, and wherein the vertical displacement of the forward end and the rearward end of the register assembly is configured to form an elevated configuration of an entirety of the register assembly.

12. A vehicle dashboard assembly, comprising:
a substrate configured to be secured to a vehicle body structure;
a topper panel operably coupled to the substrate;
a register assembly engaged with the topper panel, wherein the register assembly is positioned on a top surface of the topper panel such that the register assembly is elevated relative to the topper panel, the register assembly includes:
a register carrier operably coupled to the substrate, wherein the register carrier defines an open area;
a top cover coupled to the register carrier, wherein top cover encloses the open area; and
a cap extending from the top cover to abut the topper panel, wherein the cap creates an interface with the topper panel to form a slope, and wherein the slope is configured to position the register assembly on top of the surface of the topper panel.

13. The vehicle dashboard assembly of claim 12, further comprising:
an air register disposed in the register carrier, wherein the register carrier defines an airflow opening proximate the air registers; and
a lip portion coupled to the substrate and engaged with the register carrier, wherein the lip portion is positioned proximate the airflow opening of the register carrier such that air released by the air register contacts the lip portion.

14. The vehicle dashboard assembly of claim 12, further comprising:
a speaker housing including a grille portion, wherein the speaker housing is positioned in a central location along the top cover.

15. The vehicle dashboard assembly of claim 14, wherein the register assembly includes a speaker disposed in the open area of the register carrier proximate the speaker housing.

16. A vehicle dashboard assembly, comprising:
a topper panel secured to a vehicle body; and
a register assembly engaged with the topper panel, wherein the register assembly is vertically displaced from the topper panel such that the register assembly is disposed on the topper panel, the register assembly including:
a register carrier coupled to the vehicle body, wherein the register carrier defines an open area; and
a top cover coupled to the register carrier configured to cover the open area, wherein the top cover includes a front edge and a rear edge.

17. The vehicle dashboard assembly of claim 16, further comprising:
a cap extending from the rear edge of the top cover to abut the topper panel, wherein the cap creates an interface with the topper panel to form a slope such that the register assembly is elevated relative to the topper panel.

18. The vehicle dashboard assembly of claim 17, wherein the top cover includes a flange defining a slot and the cap includes a clip, and wherein the slot of the top cover is configured to receive the clip of the cap.

19. The vehicle dashboard assembly of claim 17, wherein the slope defines a height measuring between 10 mm and 30 mm.

20. The vehicle dashboard assembly of claim 16, further comprising:
a speaker housing operably coupled to the top cover, wherein the speaker housing includes a grille portion; and
a speaker cover configured to engage with the speaker, wherein the speaker cover and the speaker housing are positioned in a central location relative to the top cover.
